(19) United States
(12) Patent Application Publication
(10) Pub. No.: US 2026/0105482 A1
(43) Pub. Date: Apr. 16, 2026

(54) METHOD AND SYSTEM FOR DISTRIBUTING A CRYPTOGRAPHIC DIGITAL ASSET ASSOCIATED WITH A RETAIL PRODUCT TO A PURCHASER OF THE RETAIL PRODUCT

(71) Applicant: ASICS Corporation, Kobe, Hyogo (JP)

(72) Inventor: Joseph Robert Pace, Boston, MA (US)

(73) Assignee: ASICS Corporation, Kobe, Hyogo (JP)

(21) Appl. No.: 19/117,964

(22) PCT Filed: Oct. 10, 2023
(86) PCT No.: PCT/US2023/076487

§ 371 Date: Apr. 3, 2025

Related U.S. Application Data
(63) Continuation-in-part of application No. 18/051,766, filed on Nov. 1, 2022, now abandoned.

(51) Int. Cl. G06Q 30/0226; G06Q 20/38; G06Q 30/0207

(52) U.S. Cl. CPC G06Q 30/0226; G06Q 20/389; G06Q 30/0222; G06Q 2220/00

(57) ABSTRACT

A method or distributing a cryptographic digital asset associated with a retail product to a purchaser of the retail product includes: receiving a transaction confirmation indicative of a completed transaction of the retail product by the purchaser; generating and minting the cryptographic digital asset; associating, upon receiving the transaction confirmation, the cryptographic digital asset with the retail product; transmitting transactional information to a blockchain ledger to record a transfer of the cryptographic digital asset; sending the cryptographic digital asset to the purchaser; and issuing an authorization for a user reaching a predetermined criterion of cryptographic digital assets to access to an exclusive benefit. A system for distributing a cryptographic digital asset associated with a retail product to a purchaser of the retail product and a non-transitory computer readable medium for the same are also provided.

### TECHNICAL FIELD

The present disclosure is directed to building marketing programs in the token-gated commerce, and more particularly to a method and system for distributing a cryptographic digital asset associated with a retail product to a purchaser of the retail product that allows e-commerce consumers to automatically obtain exclusive benefits upon purchasing a product.

### BACKGROUND

The development of high-speed internet has changed the fundamentals of business transactions in many ways. In the first stage of development of the World Wide Web, the term Web 1.0 was developed. It refers to the earliest version of the internet that offered users the ability to read and research. It was the original version of the internet and did not allow the users to interact with what they were reading. In such an era, a few people were creating web content for large groups of readers, allowing the users to obtain information. The web became more interactive during the next stage, known as Web 2.0. In this era, more users were starting to develop their own content for the growing audience, and it focused on participation and contribution from other users. Blogs, video sharing platforms, and social media are some examples of Web 2.0. During this time, big tech companies provided internet services while monopolizing users' personal information. Because security breaches continue to be on the rise, many users started to feel uncomfortable with the centralized platforms that are entrusted with users' highly confidential information.

In recent years, Web 3.0 (also referred to as Web3) has emerged that incorporates concepts such as decentralization of platforms, and blockchain technologies. Blockchain is a shared ledger that facilitates the process of recording transactions and tracking assets in a business network. A list of records (known as “blocks”) contains a mathematical algorithm that map data of the previous blocks linked together to form a “chain” thereby creating a “blockchain.” Some of the major benefits of blockchain are enhanced security and greater transparency. The blockchain is resistant to subsequent manipulation of records because once the transaction is recorded, the public is able to see it, and it cannot be altered retroactively without affecting the later blocks. This enhanced measure of security is inherent in blockchain technology that attracts the users.

Around the same time, NFT (non-fungible token) was created in order to prevent the unauthorized production and counterfeit reproduction of digital assets. NFT is a cryptographic asset on a blockchain network with unique identification codes and metadata that distinguish them from each other that cannot be copied, substituted, or subdivided. Essentially, NFT is a digital asset that provides proof of ownership and authenticity that cannot be altered.

Another concept developed around the creation of the blockchain is a smart contract. A smart contract is a computer program or a transaction protocol that is intended to automatically execute, control, or document legally-relevant events and actions according to the terms of a contract or an agreement. The contract or the agreement exists across a distributed, decentralized blockchain network. Therefore, the transactions are trackable and irreversible.

Some patents related to the generic functioning of blockchain, NFTs and smart contracts are listed below:

US20210281410A1 discloses a system and method for proof of view via blockchain, which generates and ensures proof of views of content by leveraging blockchain to verify the veracity of content views. Generating proof of views of content is utilized to determine the integrity of a content provider channel value, and thereby the integrity of a content market exchange, or channel stake marketplace.

U.S. Pat. No. 11,348,099B2 discloses a system and method for implementing blockchain-based content engagement platforms utilizing media wallets. It generally relates to distributed computing platforms for maintaining immutable ledgers and more specifically to the generation of verifiable non-fungible tokens based upon immutable ledgers using smart contracts and the granting of fine-grained permissions to access data written to immutable ledgers.

### SUMMARY

While prior arts relate to generic functions involving the blockchain and NFTs (maintaining immutable ledgers and authenticating the digital assets), the proposed invention provides a system, method, and computer-readable medium to build brand loyalty and marketing programs in the token-gated commerce using a novel technique.

It is, therefore, an object of the present disclosure to provide a method and system for a closed-loop system that allows common e-commerce customers to obtain exclusive benefits without knowing it. Another object of the present disclosure is to provide such method and system for power users that automatically give the users more value from the digital assets.

In order to achieve the object, one aspect of the present disclosure is a method for distributing a cryptographic digital asset associated with a retail product to a purchaser of the retail product, the method comprising:
receiving a transaction confirmation indicative of a completed transaction of the retail product by the purchaser;
generating and minting the cryptographic digital asset;
associating, upon receiving the transaction confirmation, the cryptographic digital asset with the retail product,
transmitting transactional information to a blockchain ledger to record a transfer of the cryptographic digital asset;
sending the cryptographic digital asset to the purchaser; and
issuing authorization for a user reaching a predetermined criterion to access an exclusive benefit.

As used herein, the term “retail product” generally means goods and services that are available to consumers. For example, it may be physical items, such as apparel, pair of shoes, reference materials, consumable items (i.e., vitamins, nutrients, etc.), and others. Retail products may also be intangible items, such as digital goods, a ticket to an event, streaming media, and others.

As used herein, the term “authorization” generally means a process of giving someone the ability to access to a resource. For example, it may be a credential when logging in to a server, digital key, one-time password, or anything involving a security process that determines a user's level of access.

In one embodiment, the method may further comprise transmitting the subsequent transaction information from the purchaser to successional purchasers to the blockchain ledger to record the transfer of the cryptographic digital asset.

In addition or alternatively, the predetermined criterion uses a tiered level system wherein further benefits are provided at each level.

In addition or alternatively, the transactional information includes a unique retail product identification code and a unique owner identification code.

In addition or alternatively, the purchaser receives a Brand Badge NFT that provides access to a token-gated online community.

In addition or alternatively, the exclusive benefit is a physical asset, digital asset, exclusive discount, or special experience.

Another aspect of the present disclosure is a system for distributing a cryptographic digital asset associated with a retail product to a purchaser of the retail product, the system comprising:
a communication unit receiving and sending information via a network, and
a processor coupled to the communication unit, wherein
the communication unit receives a transaction confirmation indicative of a completed transaction of the retail product by the purchaser,
the processor is configured to implement the steps of:
   generating and minting the cryptographic digital asset;
   associating, upon receiving the transaction confirmation, the cryptographic digital asset with the retail product;
   transmitting transactional information to a blockchain ledger via the communication unit to record a transfer of the cryptographic digital asset;
   sending the cryptographic digital asset to the purchaser via the communication unit; and
   issuing authorization for a user reaching a predetermined criterion to access an exclusive benefit.

The processor may be, but not limited to, a general-purpose processor or a dedicated processor specialized for a specific process. The processor includes a microprocessor, a central processing unit (CPU), an application specific integrated circuit (ASIC), a digital signal processor (DSP), a programmable logic device (PLD), a field programmable gate array (FPGA), a controller, a microcontroller, and any combination thereof.

In one embodiment, the processor is configured to further implement the step of transmitting subsequent transaction information from the purchaser to successional purchasers to the blockchain ledger to record the transfer of the cryptographic digital asset.

In addition or alternatively, further benefits are provided at each level and the exclusive benefit and an NFT badge are linked in the blockchain ledger.

In addition or alternatively, the transactional information includes a unique retail product identification code and a unique owner identification code.

In addition or alternatively, the purchaser has an option to sell the cryptographic digital asset on a secondary marketplace.

In addition or alternatively, the exclusive benefit is a physical asset, digital asset, exclusive discount, or special experience.

Another aspect of the present disclosure is a decentralized computing system for distributing a cryptographic digital asset associated with a retail product to a purchaser of the retail product, the decentralized computing system comprising:
a retailer server,
a digital asset management server having a processor,
a blockchain ledger,
an exclusive benefit management server, and
a user terminal, wherein
the retailer server is configured to, upon completion of a purchase of the retail product by the purchaser, send transaction confirmation indicative of a completed transaction of the retail product to the digital asset management server,
the digital asset management server is configured to:
   generate and mint the cryptographic digital asset;
   associate, upon receiving the transaction confirmation, the cryptographic digital asset with the retail product;
   transmit transactional information to the blockchain ledger;
   send the cryptographic digital asset to the user terminal; and
   issue an authorization for a user reaching a predetermined criterion to access to the exclusive benefit management server,
the blockchain ledger is configured to record a transfer of the cryptographic digital asset, and
the exclusive benefit management server storing the exclusive benefit and is configured to allow the user having the authorization to access the exclusive benefit.

In one embodiment, the digital asset management server is further configured to transmit subsequent transaction information from the purchaser to successional purchasers to the blockchain ledger, and the blockchain ledger is further configured to record the transfer of the cryptographic digital asset.

In addition or alternatively, different levels of exclusive benefits are determined by a timing of the purchase.

In addition or alternatively, the transactional information includes a unique retail product identification code and a unique owner identification code.

In addition or alternatively, the purchaser has an option to sell the cryptographic digital asset on a secondary marketplace.

In addition or alternatively, the exclusive benefit is a physical asset, digital asset, exclusive discount, or special experience.

A non-transitory computer readable medium may be used to store a program configured to cause an information processing device to execute the above-mentioned method for distributing a cryptographic digital asset associated with a retail product to a purchaser of the retail product.

A non-transitory computer readable medium may be used to store a program for causing a computer to function as the above-mentioned system for distributing a cryptographic digital asset associated with a retail product to a purchaser of the retail product.

These and other aspects may be understood more readily from the following description and the appended drawings.

### BRIEF DESCRIPTION OF THE DRAWINGS

For a more complete understanding of the disclosed methods and apparatus, reference should be made to the implementations illustrated in greater detail I the accompanying drawings, wherein:

FIG. 1 is a general flow diagram illustrating a method for distributing a cryptographic digital asset associated with a retail product to a purchaser of the retail product in accordance with one aspect of the present disclosure;

FIG. 2 is one example of a graphical user interface that facilitates the display of a retail product;

FIG. 3 is one example of a graphical user interface that facilitates the display of order summary;

FIG. 4 is a flow diagram illustrating how smart contract sends purchase confirmation;

FIG. 5 is a schematic overview of a system for distributing a cryptographic digital asset associated with a retail product to a purchaser of the retail product in accordance with another aspect of the present disclosure;

FIG. 6 is a block diagram of the system shown in FIG. 5; and

FIG. 7 is a schematic overview of a decentralized computing system for distributing a cryptographic digital asset associated with a retail product to a purchaser of the retail product in accordance with another aspect of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The present disclosure will be described below with reference to the drawings. However, this disclosure may be embodied in many different forms and should not be construed as limited to the embodiments disclosed below. Rather, these embodiments are provided so that this disclosure will be thorough and complete, and will fully convey the scope of the disclosure to those skilled in the art. Thus, the following detailed description is not to be taken in a limited sense.

Unlike common online purchase where physical products are sold and the consumer needs to wait for some time before something of value is delivered to a purchaser, the techniques disclosed herein allows the purchaser to obtain something of value in real-time, as soon as the purchase is made.

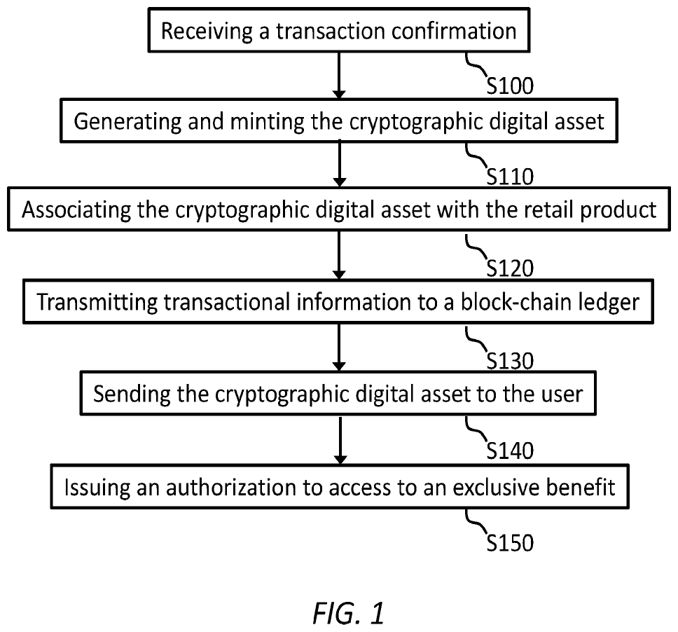

Referring to FIG. 1, a general flow diagram illustrating a method for distributing a cryptographic digital asset associated with a retail product to a purchaser of the retail product in accordance with one aspect of the present disclosure is shown. This method can be used for selling retail products in a closed loop token gated e-commerce.

When a purchaser purchases a retail product, such as footwear, apparel, or other wearable items, at a retail store, via a mail, or online, and the payment has been verified and/or predetermined conditions have been met for the purchased retail product, a transaction confirmation indicative of a completed transaction of the retail produce by the purchaser is generated. At step S100, the transaction confirmation is received by a system for distributing a cryptographic digital asset associated with a retail product to a purchaser of the retail product.

At step S110, the cryptographic digital asset is generated and minted. The cryptographic digital asset is a type of private asset that depends primarily on cryptography and distributed ledger or similar technology as part of their perceived or inherent value. For example, the cryptographic digital asset may include, but not limited to, a non-fungible token, a badge, an artwork, or any digital items that convey value to consumers. An example of a cryptographic digital asset may be a unique token that may be recorded in a blockchain and it may include metadata describing content, authorship, ownership, and/or other appropriate information of the non-fungible token.

Minting the cryptographic digital asset involves authenticating data and creating new blocks in the blockchain through a proof of stake protocol. Then the cryptographic digital asset is generated for the first time and minted. In this embodiment, step S110 is performed after the purchase was completed and the transaction confirmation was received by the system. However, the cryptographic digital asset may be generated prior to the transaction.

Upon receiving the transaction confirmation, the cryptographic digital asset is associated with the retail product at step S120. In other words, the cryptographic digital asset is exclusively owned by the purchaser of the associated retail product. Alternately, the cryptographic digital asset does not have to be associated or linked to a specific product. The cryptographic digital asset may be linked to a specific service. For example, a service may include, but is not limited to, sporting events such as athletic competitions (i.e., entry or registration, ticketing and reservations, venue allocations, augmented or virtual reality associated with an event). The cryptographic digital asset may also be associated or be linked to viewing of the event or athletic performance tracking or monitoring.

Thereafter, at step S130, transactional information is transmitted to a blockchain ledger to record a transfer of the cryptographic digital asset. This provides a public certificate of authenticity and proof of ownership of the cryptographic digital assets.

At step S140, the cryptographic digital asset is sent to the purchaser. After receiving the cryptographic digital asset, the purchaser may enjoy selling it on the secondary market.

Alternatively, the purchaser may collect the cryptographic digital asset. In this case, when the collection of the cryptographic digital asset reaches a certain criterion determined by the manufacturer and/or the third party retailer, authorization for that purchaser to access the exclusive benefit is issued (step S 150) and the purchaser may enjoy further benefits. The criterion may involve a tiered level system wherein further benefits are provided each level. As an example, a purchaser may start at a level zero, and may be able to achieve a level 10 or higher. There may be certain benefits associated with a level 2, and additional benefits may be associated at a level 7. These levels may relate to fungible or non-fungible cryptographic digital assets or tokens.

The criterion may involve quantity or quality of transactions, dates, or ID numbers. For example, the quantity may refer to the number of purchases made (i.e., purchase five and it allows the user to reach another level) or total value of the purchase. The total value of purchase may refer to individual transaction or accumulated value of purchases during a period determined by the manufacturer and/or the third party retailer. The quality of transaction may refer to product's (or service's) life cycle of the product. For example, if a purchaser purchases a product earlier in the product's life cycle, there may be a superior benefit, as opposed to obtaining the product at the end of the product's life cycle. The quality of transaction may also refer to the price of the transaction. For example, more expensive purchases may be associated with a higher quality of transaction. Alternately, quality of transaction may refer to a purchaser's early adoption of a product. For example, the first 100 purchasers of a cryptographic asset may receive a superior benefit compared to purchasers 101-1,000. Rarity of the product may also contribute to the quality of the transaction. It may also refer to duration of ownership of NFTs, length of purchasing history, or engagement in a community (being active in the community may reach higher levels of cryptographic digital asset). Another example of criterion may be ID numbers. For example, ID numbers below a certain value (i.e., #100) may allow entry two weeks before the event (as opposed to ID number starting from #101 may enter three days before the event). Similarly, ID numbers below #100 may enjoy all of the benefits, which ID numbers over #101 may enjoy limited benefits.

The further benefits may include receiving a special physical asset, another digital asset, an exclusive discount, a special experience, early access to various events (community, event, shoe drop, early invitation to purchase product, future air drops, token gated access to participate in an event or additional promotions), or otherwise creating a loyalty loop for consumers. For example, a special physical asset may include customized shoes that allow a purchaser to include the name or initial of the purchaser (e.g., “JP” or “Joe Pace”) on a certain location on the shoes. The name may be placed on the exterior surface of the shoes, on the shoe tongue, or imprinted on the sole of the shoes. The further benefit may also allow the purchaser to design and choose the colors of the shoes. Likewise, special experience may include entrance to special events which may include, participation in a race, marathon, scavenger hunt, charity event where participants may enjoy playing a game with his favorite athletes, or anything manufacturer and/or third party determines appropriate for rewarding a loyal purchaser. When access to these benefits becomes available to the users, the users may be notified with issue authorization. Depending on the situation, the users may not be provided with the issue authorization when access to the benefit becomes available (i.e., surprise gift to the user). In some embodiments, access to the benefits may be automatic. In other embodiments, access to the benefits may require the user to take further action in order to access the benefits.

The exclusive benefit may have multiple levels, each level having a different reward or benefit. In some situations, receiving the exclusive benefit may depend on the timing of the purchase. For example, a first purchaser may be rewarded with a higher level than a second purchaser who makes a transaction later than the first purchaser. In other situations, the second purchaser who makes the transaction later than the first purchaser may receive a higher level of reward or benefit. Yet in other situations, the timing of receiving the higher level of reward or benefit may be determined by the manufacturer or the third party retailer during a special shopping campaign. The levels may be represented by the symbols that are used to reward individuals (i.e., silver, gold, or platinum).

In some situations, the cryptographic digital asset may be altered depending on the situation. For example, multiple cryptographic digital assets may be merged (or spliced) to a single cryptographic digital asset in order to move up in the level. In other situations, multiple cryptographic digital assets may be merged (or spliced) to form a smaller number of the cryptographic digital assets. Likewise, the cryptographic digital asset has an ability to split to multiple cryptographic digital assets. For example, a Level 4 cryptographic digital asset may be split into four Level 1s, or one Level 3 and one Level 1, as long as the splitting value is not more than the original level value. The ability to split may have restrictions in how many times it can split (i.e., it can split only three times).

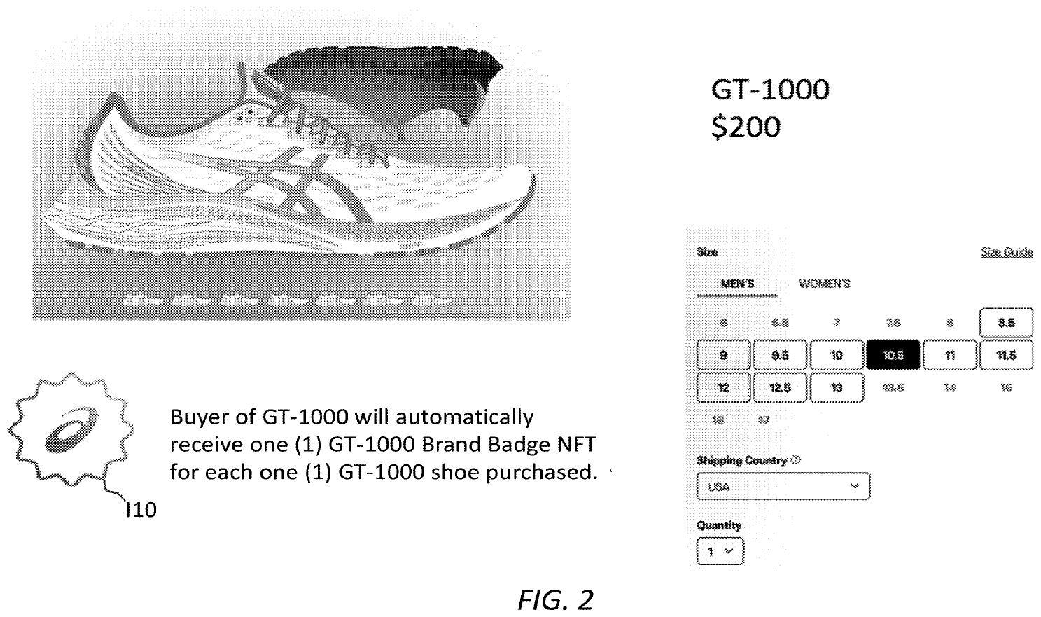

The step of receiving a transaction confirmation S100 is further explained with reference to FIG. 2 which illustrates an example of a graphical user interface that facilitates the display of a retail product. In this example, the retail product is footwear. On the graphical user interface, a pair of shoes is displayed along with other information pertaining to the product. The information may include gender, size, shipping country, quantity, or others. Image I10 depicting a star with a brand logo is placed just below the image of the pair of shoes. This image may indicate that if a purchaser buys a pair of shoes, the purchaser will also receive a cryptographic digital asset. The image can be anything as long as the purchaser is able to recognize that a special benefit will be accompanying the product being purchased. Just to illustrate this point, near the image of the special benefit, it states “Buyer of GT-1000 will automatically receive one (1) GT-1000 Brand Badge NFT for each one (1) GT-1000 purchased.” In this example, the cryptographic digital asset does not exist at this point. The cryptographic digital asset relating to the purchase of GT-1000 will be created once the purchaser buys the product, which will be explained below. When the purchaser indicates the required information (i.e., size, shipping country, quantity, etc.), the purchaser is led to another page to proceed forward with the transaction.

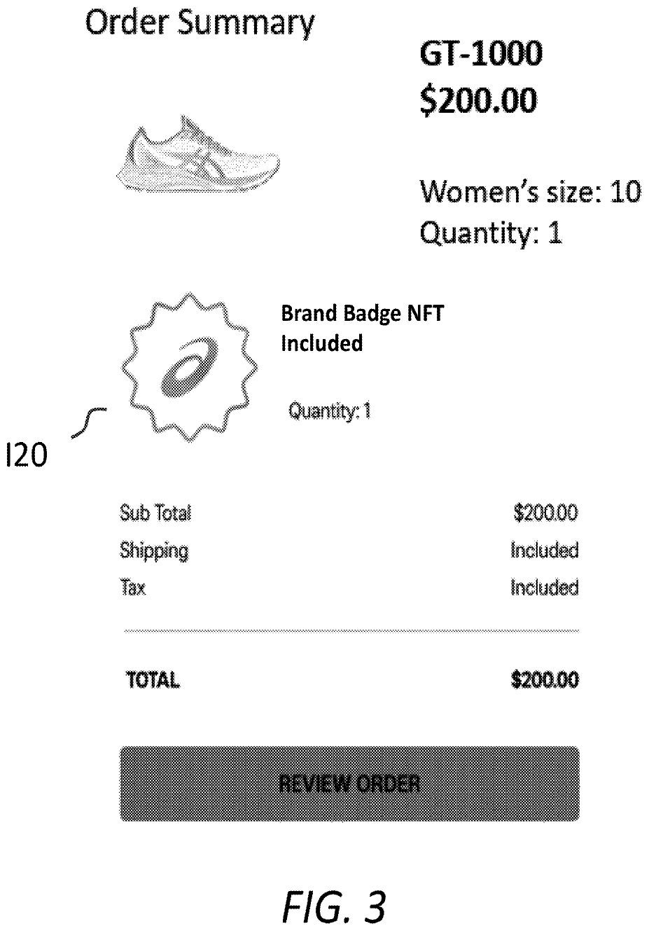

FIG. 3 is an example of the graphical user interface that facilitates the display of the order summary. On this page, the purchaser confirms that when the pair of shoes is purchased, the purchaser will also receive the Brand Badge NFT (or NFT Badge) as shown in I20. The Brand Badge NFT may represent some types of community or types of groups and may be linked to the exclusive benefit discussed above. For example, a Brand Badge NFT may represent nationalities, hobbies, teams, types of sports, colors, or any idea that conveys sense of community, social validations, or credibility. The Brand Badge NFT may be shared with multiple members. For example, a group of the Brand Badge NFT owners may form an exclusive community (such as country club) which the members are charged with membership fees to join the community. Alternately, the community formation may not require membership fees. In other situations, the users may own the same badges, same color badge, or same sports badge through purchasing the same products. In other words, the members can form a community group with other members who have similar preferences, hobbies or lifestyle. In other situations, the users may create a token-gated community, such as an online forum or other group or club where the token acts as the key or access verification. In other embodiments, entrance to the community may be based on the value of the cryptographic digital asset. Yet in other situations, joining the group may be free since members are in the same family. If a Brand Badge NFT is shared, it may have multiple profiles associated with it. Once the purchaser decides to pay for the product, the request to purchase is sent to the smart contract in a communication unit. For example, when a purchaser visits a seller's website and decides to purchase and pay for a product by clicking on “Buy”, the signal is sent to a smart contract in the communication unit. Alternately, a Brand Badge may track and keep a record of regular purchases from members associated with the Brand Badge, such as the purchase of shoes or apparel.

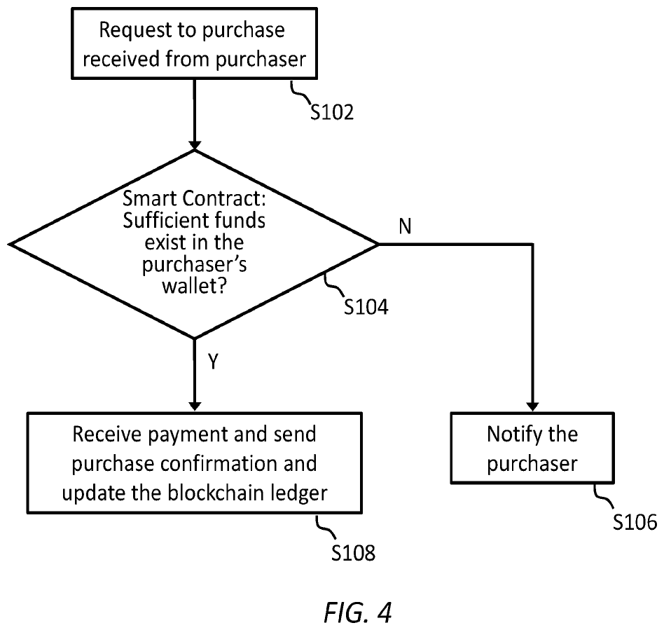

FIG. 4 is a flow diagram illustrating how a smart contract sends purchase confirmation. The smart contract is a code that can be executed automatically, and it is stored and executed on the blockchain. Efficient coding and deployment may be considered in the smart contract to reduce energy consumption. In the smart contract, the terms of the purchase, refund policy, special sales, or anything related to the terms of the transaction may be programmed. The smart contract is capable of receiving, storing, and sending commercial transactions, and it is a part of a communication unit of the system. Also in the system, product, purchaser, retail platform, web3 platform and the like may be linked. When the transaction is recorded on the blockchain, anyone with an access can view the transaction history.

When the purchaser sends an indication to purchase a product (step S102), the smart contract determines whether sufficient funds exist in the purchaser's digital wallet (step S104). If the smart contract determines that there are not sufficient funds in the purchaser's digital wallet, the smart contract will promptly send a message, notifying the purchaser of the insufficient funds and requesting the purchaser to make an additional deposit to the digital wallet (step S106). The digital wallet may manage actual currency (i.e., the official currency of a country) or digital currency. On the other hand, if the smart contract determines that sufficient funds exist in the digital wallet, it receives the required payment and sends a transaction confirmation (step S108). At the same time, a request to generate and mint the cryptographic digital asset is sent to the blockchain ledger. An example of a cryptographic digital asset may be a unique token that may be recorded in a blockchain and it may include metadata describing content, authorship, ownership, and/or other appropriate information of the non-fungible token. Minting the cryptographic digital asset involves authenticating data and creating new blocks in the blockchain through a proof of stake protocol. Then the cryptographic digital asset is generated for the first time and minted which happened moments after the purchase was completed. Subsequently, the cryptographic digital asset is sent to the purchaser.

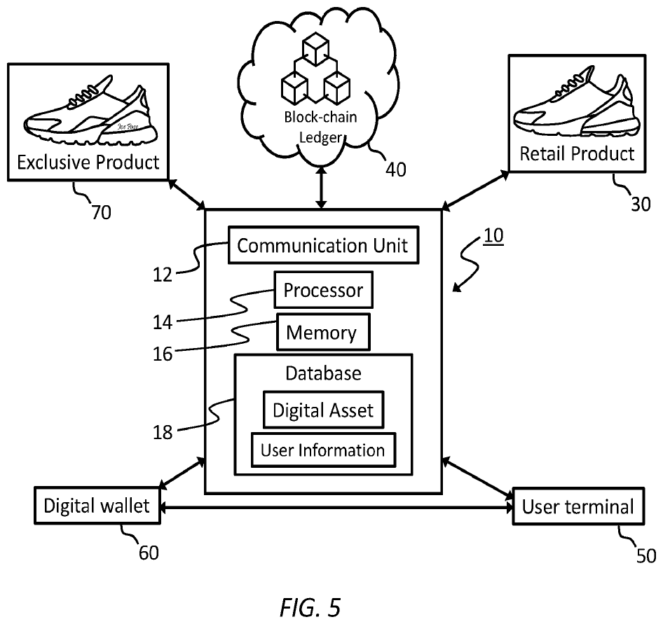

Referring now to FIG. 5, a schematic overview of a system in accordance with an embodiment of the present disclosure is shown. The system 10 includes a communication unit 12, processor 14, memory 16, and database 18. The communication unit 12 may communicate with a retailer server 30, a blockchain ledger 40, a user terminal 50, a digital wallet 60, and an exclusive benefit management server 70 by sending and retrieving relevant information via a network. The communication network may be an ad hoc network, a local area network (LAN), a metropolitan area network (MAN), a wireless personal area network (WPAN), a public switched telephone network (PSTN), a terrestrial wireless network, an optical network, or any combination thereof. A person skilled in the art would appreciate that there are many ways a communication unit may connect to the network to exchange information, and embodiments of the present disclosure are contemplated for use with any method for connecting to external devices for the purpose of exchanging information. Although the present embodiment considers utilizing high-speed connections, connections of any speed may be used. For example, when a purchaser uses the user terminal 50 to shop for a product and finds a product that the purchaser would like to purchase, the purchaser sends a request to purchase (i.e., clicking on “Order”) which is sent to the system 10 via the network. When the communication unit 12 receives the information, it prompts the processor 14 to determine whether the purchaser has sufficient funds by communicating with the purchaser's digital wallet 60 via communication unit 12 as discussed above. If the digital wallet 60 determines that sufficient funds exist, it transfers the fund required for the payment and sends a transaction confirmation to the system 10. Alternatively, the request to purchase may be sent to the retailer server 30, and the retailer server 30 communicates with the digital wallet 60 to determine whether the purchaser has sufficient funds. If the digital wallet 60 determines that sufficient funds exist, it transfers the fund required for the payment and sends a transaction confirmation to the retailer server 30 which subsequently sends the transaction confirmation along with other information pertaining to the product purchase to the system 10. Furthermore, the database is not limited to certain types. For example, the database may include, but is not limited to document database, key-value stores, column-oriented databases, graph databases, or any program that may store various information.

When the transaction confirmation indicative of the completed transaction is received, the generation of the cryptographic digital asset and minting process starts by utilizing the processor 14, memory 16, and database 18. Then, the processor 14 associates the generated cryptographic digital asset with the retail product or the purchaser's digital wallet 60. At the same time, the commercial transaction information is transmitted to the blockchain ledger 40 via the network. The commercial transaction information may include a unique product identification code and/or a unique owner identification code. For example it may be a two-dimensional matrix barcode, serial number, or tracing code of customer purchase history. When these processes are completed, the processor 14 sends the cryptographic digital asset that was just minted to the purchaser by transmitting it via the communication unit 12 to the user terminal 50. After receiving the cryptographic digital asset, the purchaser may enjoy selling it on the secondary market.

Alternatively, the purchaser may collect the cryptographic digital asset. In this case, the processor 14 determines whether the collection of the cryptographic digital asset reaches a certain criterion determined by the manufacturer and/or the third party retailer. When the criterion is determined to be met, the processor 14 issues an authorization for that purchaser to access to the exclusive benefit. The authorization allows the purchaser to access the exclusive benefit management server 70. The exclusive benefit management server 70 manages cryptographic digital assets that have been associated with the retail product, and sends a signal to the system 10 when the purchaser has access to an exclusive benefit. In this embodiment, the cryptographic digital asset is generated after the purchase was completed and the transaction confirmation was received by the system 10. However, the cryptographic digital asset may be generated prior to the transaction. Also, the exclusive benefit is managed by the exclusive benefit management server 70 independent from the system 10 in this embodiment. However, the system 10 may integrate the exclusive benefit management server 70 or the function thereof.

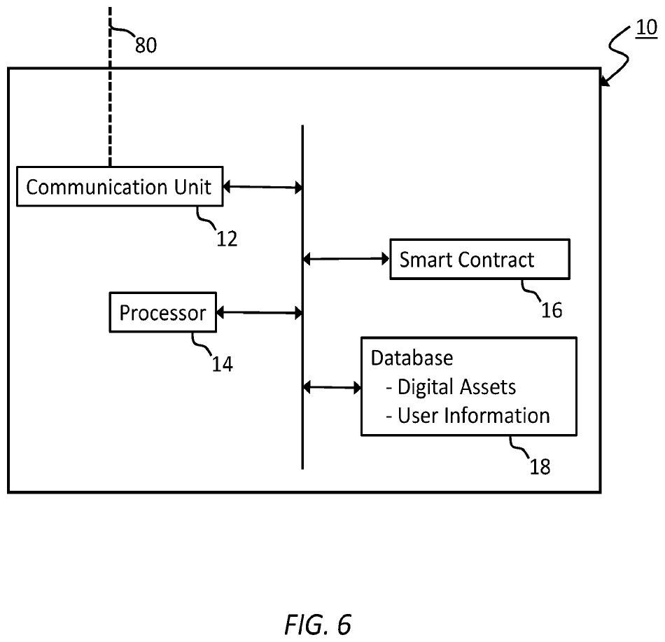

FIG. 6 illustrates a block diagram of the system 10. The system 10 communicates with the outside of the system via the network 80. Components or modules of the system may connect with external connections in many ways. A person skilled in the art would appreciate that there are many ways in which components or modules may utilize and connect to external connections. For example, a module or component may link to an external connection through a computing device directly connected to the wide area network (WAN), through a routing device, through a computing device connected to a wireless access point, or other similar methods. Appropriate communication means may include, for example, wireless connection, wired connection, cellular connection, data port connection, near field connection, or any similar means of connection and any combination thereof. A person skilled in the art would appreciate that there are many communication means that may be utilized with embodiments of the present disclosure.

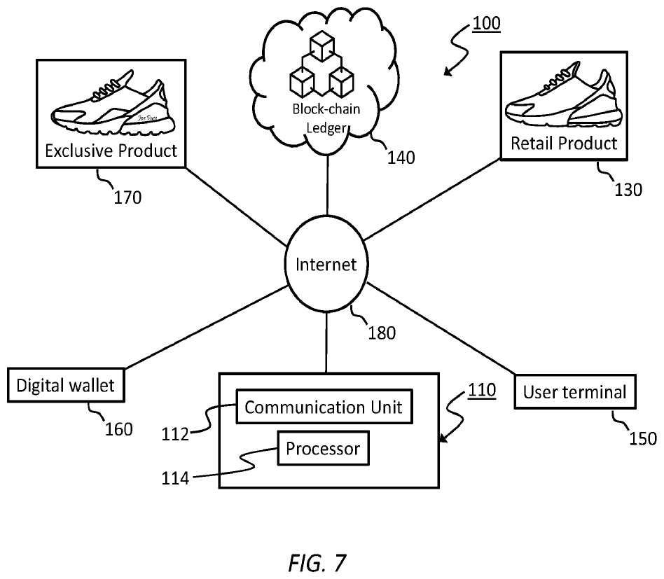

FIG. 7 illustrates a schematic overview of a decentralized computing system for distributing a cryptographic digital asset associated with a retail product to a purchaser of the retail product in accordance with another aspect of the present disclosure. In this embodiment, the system 100 includes a digital asset management server 110 having a processor 114, a retailer server 130, a blockchain ledger 140, a user terminal 150, and an exclusive benefit management server 170. Each of them is coupled to a network 180 such as the internet and can communicate with each other via the network. When a purchaser uses the user terminal 150 to shop for a product and finds a product that the purchaser would like to purchase, the purchaser sends a request to purchase (i.e., clicking on “Order”) which is sent to the retailer server 130 via the network 180. When the retailer server 130 receives the information, it determines whether the purchaser has sufficient funds. The system 100 may further include a digital wallet 160 which is also coupled to the network 180, and the determination can be performed, for example, by communicating with the purchaser's digital wallet 160 via the network 180. The system 100 may use the smart contract for the transaction as discussed above. If sufficient funds exist in the digital wallet 160, the retailer server 130 charges the price of the purchased product from the digital wallet 60 and sends transaction confirmation indicative of a completed transaction of the retail product to the digital asset management server 110. The digital asset management server 110 includes a communication unit 112 coupled to the network 180 and a processor 114 for performing the steps discussed below. The digital asset management server 110 generates and mints the cryptographic digital asset and, upon receiving the transaction confirmation, associates the cryptographic digital asset with the retail product. The cryptographic digital asset may be generated and minted before receiving the transaction confirmation, or alternatively, the transaction confirmation may initiate generating and minting the cryptographic digital asset. Thereafter, the digital asset management server 110 transmits transactional information to the blockchain ledger 140 and sends the cryptographic digital asset to the user terminal 150. Then, blockchain ledger 140 records a transfer of the cryptographic digital asset. The digital asset management server 110 further determines whether the user reaches a predetermined criterion of cryptographic digital assets and, if reaches, issues an authorization for a user to access to the exclusive benefit management server 170. The exclusive benefit management server 170 stores the exclusive benefit and allows the user having the authorization to access the exclusive benefit. The exclusive benefit management server 170 may be configured to send a signal to the digital asset management server 110 when the purchaser has access to an exclusive benefit.

Structures of the system for distributing a cryptographic digital asset and the decentralized computing system for distributing a cryptographic digital asset are interchangeable. The disclosures described above are not intended to be limited. Rather, the above disclosures are intended to be as broad in scope as the art will allow. For example, in the embodiment illustrated in FIG. 7, the retailer server 130 facilitates the transaction of funds. However, the digital asset management server 110 may be configured in the same manner as the system 10 discussed above with reference to FIG. 5 to facilitate the transaction of funds.

The above-discussed steps may be stored in a non-transitory computer readable medium as a series of operations or a program related to the operations that is executed by a computer system or other hardware capable of executing the program. In addition, the operations may be performed by a dedicated circuit implementing the program codes, a logic block or a program module executed by one or more processors, or the like.

As used herein, various terminology is used for the purpose of describing particular implementations only and is not intended to be limiting. The term “coupled” is defined as connected, although not necessarily directly, and not necessarily mechanically; two items that are “coupled” may be unitary with each other. The terms “a” and “an” are defined as one or more unless this disclosure explicitly requires otherwise. The phrase “and/or” means and or. To illustrate, A, B, and/or C includes: A alone, B alone, C alone, a combination of A and B, a combination of A and C, and combination of B and C, or a combination of A, B, and C. In other words, “and/or” operates as an inclusive or. Additionally, the phrase “A, B, C, or combination thereof” or “A, B, C, or any combination thereof” includes: A alone, B alone, C alone, a combination of A and B, a combination of A and C, a combination of B and C, or a combination of A, B, and C.

The term “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps, but is not limited to possessing only those one or more steps.

Further, a device or system what is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill further appreciate that the various illustrative logical blocks, modules, circuits, and algorithm steps or devices described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on overall system. Skilled artisans may implement the described functionality in varying ways for each particular application, but such implementation decisions should not be interpreted as causing a departure from the scope of the present disclosure. Skilled artisan will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designated to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the method and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus-or step-plus-function limitations, unless such a limitation is explicitly recited in a given claim using the phrase(s) “means for” or “step for,” respectively.

Although the aspects of the present disclosure and other advantages have been described in detail, it should be understood that various changes, substitutions, and alterations can be made herein without departing from the spirit of the disclosure as defined by the appended claims. Moreover, the scope of the present application is not intended to be limited to the particular implementations of the process, machine, manufacture, composition of matter, means, methods and steps described in the specifications. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, composition of matter, means, methods, or steps.

1. A method for distributing a cryptographic digital asset associated with a retail product to a purchaser of the retail product, the method comprising:
receiving a transaction confirmation indicative of a completed transaction of the retail product by the purchaser;
generating and minting the cryptographic digital asset;
associating, upon receiving the transaction confirmation, the cryptographic digital asset with the retail product;
transmitting transactional information to a blockchain ledger to record a transfer of the cryptographic digital asset;
sending the cryptographic digital asset to the purchaser; and
issuing authorization for a user reaching a predetermined criterion to access an exclusive benefit.

2. The method for distributing a cryptographic digital asset associated with the retail product to the purchaser of the retail product according to claim 1, further comprising transmitting subsequent transaction information from the purchaser to successional purchasers to the blockchain ledger to record the transfer of the cryptographic digital asset.

3. The method for distributing a cryptographic digital asset associated with the retail product to the purchaser of the retail product according to claim 1, wherein the predetermined criterion uses a tiered level system wherein further benefits are provided at each level.

4. The method for distributing a cryptographic digital asset associated with the retail product to the purchaser of the retail product according to claim 1, wherein the transactional information includes a unique retail product identification code and a unique owner identification code.

5. The method for distributing a cryptographic digital asset associated with the retail product to the purchaser of the retail product according to claim 1, wherein the purchaser receives a Brand Badge NFT that provides access to a token-gated online community.

6. The method for distributing a cryptographic digital asset associated with the retail product to the purchaser of the retail product according to claim 1, wherein the exclusive benefit is a physical asset, digital asset, exclusive discount, or special experience.

7. A system for distributing a cryptographic digital asset associated with a retail product to a purchaser of the retail product, the system comprising:
a communication unit receiving and sending information via a network, and
a processor coupled to the communication unit, wherein
the communication unit receives a transaction confirmation indicative of a completed transaction of the retail product by the purchaser,
the processor is configured to implement the steps of:
generating and minting the cryptographic digital asset;
associating, upon receiving the transaction confirmation, the cryptographic digital asset with the retail product;
transmitting transactional information to a blockchain ledger via the communication unit to record a transfer of the cryptographic digital asset;
sending the cryptographic digital asset to the purchaser via the communication unit; and
issuing authorization for a user reaching a predetermined criterion to access an exclusive benefit.

8. The system according to claim 7, wherein the processor is configured to further implement the step of transmitting subsequent transaction information from the purchaser to successional purchasers to the blockchain ledger to record the transfer of the cryptographic digital asset.

9. The system according to claim 7, wherein the predetermined criterion uses a tiered level system wherein further benefits are provided at each level and the exclusive benefit and an NFT badge are linked in the blockchain ledger.

10. The system according to claim 7, wherein the transactional information includes a unique retail product identification code and a unique owner identification code.

11. The system according to claim 7, wherein the purchaser has an option to sell the cryptographic digital asset on a secondary marketplace.

12. The system according to claim 7, wherein the exclusive benefit is a physical asset, digital asset, exclusive discount, or special experience.

13. A decentralized computing system for distributing a cryptographic digital asset associated with a retail product to a purchaser of the retail product, the decentralized computing system comprising:
a retailer server,
a digital asset management server having a processor,
a blockchain ledger,
an exclusive benefit management server, and
a user terminal, wherein
the retailer server is configured to, upon completion of a purchase of the retail product by the purchaser, send transaction confirmation indicative of a completed transaction of the retail product to the digital asset management server,
the digital asset management server is configured to:
generate and mint the cryptographic digital asset;
associate, upon receiving the transaction confirmation, the cryptographic digital asset with the retail product;
transmit transactional information to the blockchain ledger;
send the cryptographic digital asset to the user terminal; and
issue an authorization for a user reaching a predetermined criterion to access to the exclusive benefit management server,
the blockchain ledger is configured to record a transfer of the cryptographic digital asset, and
the exclusive benefit management server storing an exclusive benefit and is configured to allow the user having the authorization to access the exclusive benefit.

14. The decentralized computing system according to claim 13, wherein the digital asset management server is further configured to transmit subsequent transaction information from the purchaser to successional purchasers to the blockchain ledger, and the blockchain ledger is further configured to record the transfer of the cryptographic digital asset.

15. The decentralized computing system according to claim 13, wherein different levels of exclusive benefits are determined by a timing of the purchase.

16. The decentralized computing system according to claim 13, wherein the transactional information includes a unique retail product identification code and a unique owner identification code.

17. The decentralized computing system according to claim 13, wherein the purchaser has an option to sell the cryptographic digital asset on a secondary marketplace.

18. The decentralized computing system according to claim 13, wherein the exclusive benefit is a physical asset, digital asset, exclusive discount, or special experience.

19. A non-transitory computer readable medium storing a program configured to cause an information processing device to execute the method for distributing a cryptographic digital asset associated with the retail product to the purchaser of the retail product according to claim 1.

20. A non-transitory computer readable medium storing a program for causing a computer to function as the system for distributing a cryptographic digital asset associated with a retail product to a purchaser of the retail product according to claim 7.
